(19) United States
(12) Patent Application Publication
(10) Pub. No.: US 2017/0054780 A1
(43) Pub. Date: Feb. 23, 2017

(54) Real-time file generation and delivery

(71) Applicant: ART19, Inc., San Rafael, CA (US)

(72) Inventors: Sean Carr, San Francisco, CA (US); Johannes Vetter, Qualicum Beach (CA); Keith Gable, Richmond, CA (US)

(73) Assignee: ART19, Inc., San Rafael, CA (US)

(21) Appl. No.: 15/080,574

(22) Filed: Mar. 24, 2016

Related U.S. Application Data
(60) Provisional application No. 62/137,748, filed on Mar. 24, 2015.

(51) Int. Cl. H04L 29/06; H04L 29/08

(52) U.S. Cl. CPC H04L 65/602; H04L 67/06; H04L 65/4084

(57) ABSTRACT

The present invention provides a method implemented by a server for transmitting a content stream through a network to a client. The method comprises the steps of: (a) receiving a request from the client to play the content stream; (b) generating a list of candidate segments; (c) determining the best candidate segment for every position; (d) storing the plurality of segments; (e) sending each specified segment to the client.

### SUMMARY

In one aspect, the present invention provides a system for transmitting a file (or a file stream) through a network to a client. The system comprises a server, a segment storage unit, and an input interface configured to receive a request from the client to play the content stream. Parts of the files are stored as a plurality of segments. The segment storage unit is configured to store the plurality of segments. The server further comprises a processing unit configured to generate a master pointer list that includes a plurality of segments that could be used to create a complete file. Following further processing, the server generates a filtered pointer list, wherein the pointer list includes the segments to generate a complete file, such that a single segment corresponds to each location. The server further comprises an output interface configured to transfer a file, segment by segment to the client. The server's input interface is configured to receive a request from the client for a file. The server's processing unit is configured to obtain the requested segment from the segment storage unit. The server's output interface is configured to send the requested file segment by segment to the client.

In yet another aspect, the present invention provides a method implemented by a server for transmitting a content stream through a network to a client. The method comprises the steps of: (a) receiving a request from the client to play the content stream; (b) generating a list of candidate segments; (c) determining the best candidate segment for every position; (d) storing the plurality of segments; (e) sending each specified segment to the client.

In still yet another aspect, the present invention provides a system for providing a file through a network to a client. The system comprises content storage, an application programming interface, and a server. The server is configured to: (a) receive a request from the client for a particular file; (b) receive multiple files of the content stream provided by the content provider where the multiple files are encoded at different bit rates; (c) segment each of the multiple files into a plurality of segments; (d) store the plurality of segments.

Additional aspects of the invention will be set forth, in part, in the detailed description, figures and any claims, which follow, and in part will be derived from the detailed description, or can be learned by practice of the invention. It is to be understood that both the foregoing general description and the following detailed description are exemplary and explanatory only and are not restrictive of the invention as disclosed.

### BACKGROUND

The field of invention is generally file transfer over the internet. This invention relates to providing content in a network environment. More particularly, the invention relates to systems and methods for enabling a plurality of client computers to receive variations of files created at the time of the request.

### BACKGROUND OF THE INVENTION

The following abbreviations are herewith defined, at least some of which are referred to within the following description about at least prior art and/or the present invention.

### AFS Apple File Service

### API Application Programming Interface

### FTP File Transfer Protocol

### GPS Global Positioning System

### HTTP Hypertext Transfer Protocol

### IP Internet Protocol

### RSS Really Simple Syndication

### TFTP Trivial File Transfer Protocol

### URL Uniform Resource Locator

Browsers and media players that reside on a client computer and allow a user to download and experience a variety of dynamic content are known in the art. For example, users can download media files associated with music and listen to the music via their media player. Systems and methods are known in the art that enable media content to be packaged and delivered, via a network, in a manner that can enhance the user experience by providing a user with not only media content, but additional content that adds value to the media content. Media can be delivered over the internet in many different ways. Typically, a file must exist prior to the client request.

Media content delivery provides an opportunity to present advertisements to users. Advertisements may be placed within content, such as a web page, image or video, or the content may trigger the display of one or more advertisements, such as presenting an advertisement in an advertisement slot within the content and/or in an advertisement slot of a pop-up window or other overlay. Advertisements may also be identified and provided through interest data selected by users.

A conventional broadcast or podcast advertisement is generally targeted to all listeners regardless of demographic data or their individual interests. When a listener is present in the geographical area, he or she will receive the broadcasting program including the advertisement.

Podcasts are downloaded for offline use. Often, the same version of a podcast is heard by all of its listeners. Delivering an identical file to all clients that make the same request limits customization. To include targeted advertising, many versions of a podcast containing different sets of advertising content must be available to clients. To offer every variation requires generating every possibility of combinations prior to the request. Creating and storing an essentially infinite number of file combinations would require significant file storage in light of the required file sizes.

Current methods of providing custom advertising require downloading a plugin or application. The application or plugin ensures that custom advertising is delivered. Rather than generating a file version for every possible combination, a file could be generated after the client's request. However, generating a customized file after a client's request, waiting until that file is complete, and then sending the file to the client would take an undesirable length of time. The client must wait to download the file that's being created.

HTTP Live Streaming is a media streaming communications protocol that uses HTTP to present a media stream to a client. The HTTP Live Streaming specification defines a streaming protocol in which an overall stream is broken into a sequence of HTTP files, where each file stores one short chunk of an overall potentially unbounded transport stream. HTTP live streaming requires a whole, complete file prior to the generation of chunks of the file. The file must have a known end. The HTTP files associated with a given stream are identified in a playlist file.

At the start of a streaming session, the client downloads the playlist, which provides a URL for each chunk of the overall stream (or the various sub-streams encoded at different bit rates). As the stream is played, the client may select from a number of different alternate streams containing the same material encoded at a variety of data rates, allowing the streaming session to adapt to an available data rate. That is, the client may switch bit rates at any point it switches from the playback of one of the chunks to another.

However, the HTTP Live Streaming specification requires that each stream be broken into separate files at each point during playback where the content player may make a stream switch to manage the buffer level. Further, HTTP Live Streaming does not support HTTP range requests.

RSS/Atom clients (feed readers) do not support segmented streaming, including HTTP live streaming. HTTP live streaming is not available on as many types of devices as HTTP. HLS requires client-side HLS support. HLS playlists are not functional without an Internet connection and the ability to access the segment files. HLS makes content consumption decisions client-side, using only information available to the client. The server input is not involved in content decisions. HLS playlists are also accessed over a simple and basic HTTP URL, but require specialized software that is capable of handling the file and downloading the HLS segments.

### BRIEF SUMMARY OF THE INVENTION

The present disclosure relates generally to associating data segments of a particular medium and delivering a complete file to users. Storing parts of files and then appending parts after the client request is made, reduces the storage required and generates a uniquely appropriate file for a particular client request. The process described herein is useable by clients on any http capable system. HTTP is a widely accepted protocol, which permits various types of clients and devices to utilize the invention. Real-time file generation will require more processor usage by the business server but less disk space. Old files may be delivered with new ads. Two distinctive but otherwise identical URL requests may result in 2 different files that are delivered.

Creation of a custom file at the time of the request ensures that the most valuable content at the time of the request is downloaded by the client. Storage is only required for original media files or its segments rather than for each unique combination file.

In one embodiment, the original media content segments reside on the server's remote or local storage. The original media content segments were generated by splitting the original media files. The candidate segment list 121 is a data structure that lists the candidates that are appropriate based on the request. The candidate segment list 122 is a data structure that lists the selected candidate segments. The selected content segments 123 reside on the server's local storage. The server delivers the file segment by segment. The file 124 the client receives contains the concatenated segments 101, 102, 103, 104, 105, and 106.

### BRIEF DESCRIPTION OF THE DRAWINGS

FIG. 1 depicts the basic process of file creation from segments.

FIG. 2 depicts the basic process of file creation from segments and includes advertising.

FIG. 3 depicts the process of file creation from segments, wherein more than one segment corresponds to a single location.

FIG. 4 depicts the process of file creation from segments where the selected segment list is changed after the delivery of the first segment thus changing later segments that are delivered.

FIG. 5 depicts the production of two different files following the same URL request.

FIG. 6 depicts the system involved in the creation of files.

### DESCRIPTION

In the following detailed description, numerous specific details are set forth to provide a thorough understanding of claimed subject matter. However, it will be understood by those skilled in the art that claimed subject matter may be practiced without these specific details. In other instances, methods, apparatuses or systems that would be known by one of ordinary skill have not been described in detail so as not to obscure claimed subject matter.

The server receives a file request from client. The request parameters define what content will be delivered in the response. The process may use a request response protocol for networking between the server and client. Other request response protocols may also be used such as FTP, AFS, and TFTP. Various file and media types may be used.

The client may make the request by following a hyperlink. A hyperlink to the file may be embedded in a feed, such as a RSS or Atom, Apple Push Notification Service, a web page, or an email message. Alternatively, the hyperlink may be loaded into a media player, a mobile device, or a network connected, embedded device, such as a home or car entertainment system.

The parameters of request may include the client IP Address, approximate or exact location, and other client or user identification data.

The client requests the file over HTTP, HTTPS, SPDY, or some other request-response protocol.

Request parameters provided by the client may be sent to an external API. Parameters may include whether the user has a content subscription. The API returns a list of segments that are appropriate to deliver to the client. The API may query the data warehouse for appropriate segments, including the client requested content, advertising, and timecode dependent meta-information.

There may be alternates for each segment. Alternate collections of segments may be redundant and contain the same content at different bitrates or a different encoding. Alternatively, alternate collections of segments may contain different content, such as two different advertisements.

Segments of the original content may be generated prior to the request or during the request. Segments are broken at frame boundaries or delimiter locations. Some embodiments deliver an MP3 file. An MP3 file is composed of frames. An MP3 file is split into segments at the boundary of two frames. The split never occurs within the frame such that all fragments are composed of an integer or whole number quantity of frames.

The variety of segments allows the server to deliver multiple versions of 1 file to a plurality of clients. The parts that compose the whole file may be interchangeable. The whole versions do not need to be stored. If the required segments are not currently in local storage, the segment data is downloaded to the server's local cache.

When the request is made, the file as a whole has not been generated. The file, as a whole, may not exist in file storage. Parts of the file are stored as a plurality segments. Parts of the file may be stored on different systems. In combination a plurality of segments compose a file.

The server uses as master list of pointers, which lists the order of segments and alternate segments. Business logic is applied to determine which segment is selected ensuring only one segment is selected per position. The pointer to the selected file is added to the list.

The first segment pointer is resolved to data and is added to the input/output buffer and transfer to the client begins. The pointers on the list may be changed prior to being added to the input/output buffer. When the final segment is sent, the client will receive a single file. Once part of a segment has been sent to a client, its pointer cannot be modified.

The final file as delivered to the client may be stored in the server's local cache and then delivered to clients on subsequent identical requests with identical segment selections. Alternatively, the server may deliver each segment in order to the client without consulting the cache.

In some embodiments, the delivered file is csv. The user desires some data. The client requests table.csv. The file, table.csv, may not exist yet. The system generates a query to begin generating the table. The results might not be complete yet, but the server may begin to deliver the file in segments as they exist.

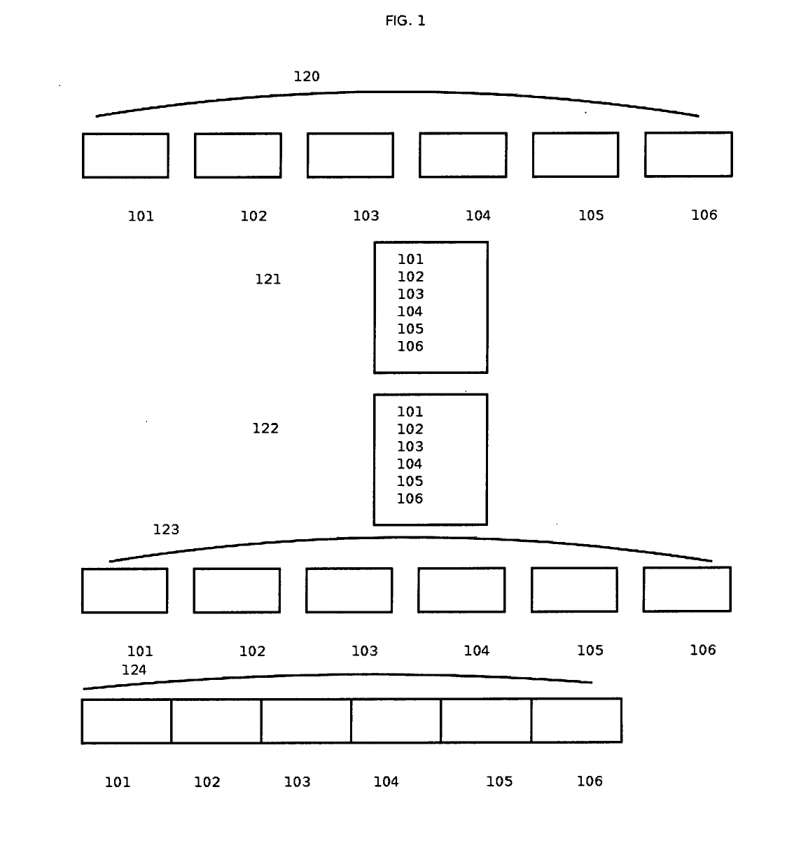

FIG. 1. depicts 120 the original content segments, the candidate segment pointer list 121, the selected segment list 122, the selected segments 123, and the complete file 124, which the client receives. Segments 101, 102, 103, 104, 105, and 106 contain some number of frames of data. The file type must have a record delimiter. The original content segments 120 reside on the server's remote or local storage. The candidate segment list 121 is a data structure that lists the candidates that are appropriate based on the request. The candidate segment list 122 is a data structure that lists the selected candidate segments. The selected content segments 123 reside on the server's local storage. The server delivers the file segment by segment. The file 124 the client receives contains the concatenated segments 101, 102, 103, 104, 105, and 106.

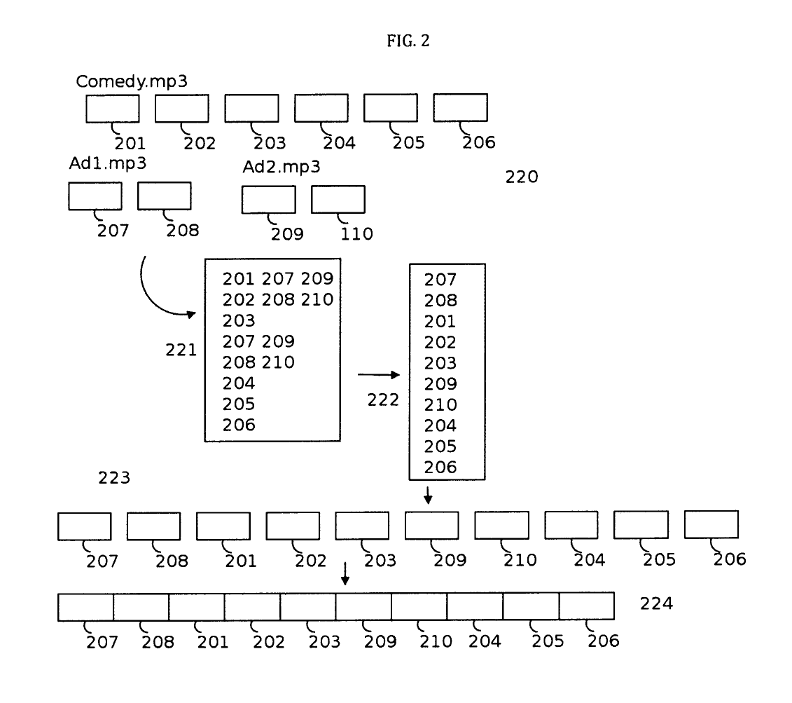

FIG. 2. depicts 220 the original content segments, the candidate segment pointer list 221, the selected segment list 222, the selected segments 223, and the complete file 224, which the client receives.

In some embodiments, the client is delivered an MP3 file with audio ads included in the file. The server receives a client request: GET /comedy.mp3. Segments 201, 202, 203, 204, 205, and 206 contain some number of MP3 frames of data. Segments 201, 202, 203, 204, 205, and 206 correspond to the request URL. The segments were previously generated from splitting the comedy.MP3 file at frame boundaries. The business desires to deliver advertising content to the client along with the comedy audio content. Locations for inserting advertisements are prior to segment 201 and between segment 203 and 104. Segments 207, 208, 209, and 210 contain some number of MP3 frames of data. The segments 107 and 108 were previously generated from splitting the ad1.mp3 and the ad2.mp3 file at frame boundaries. The segments 209 and 210 were previously generated from splitting the ad2.mp3 file at frame boundaries. The original content segments 220 reside on the server's remote or local storage.

The server computes based on user data of user who requested, the audio that was requested, which audio segments could be delivered. The candidate segment list 121 is a data structure that lists the candidates that are appropriate based on the request. Business logic is applied to determine which segments are selected. The server determines the best single segment for each position. The segment 207, 209, or 201 may be the first segment of data delivered to the client. The selected segment list 222 is a data structure that lists the selected candidate segments. The selected segment list 222 contains exactly one segment in each position. The selected content segments 223 reside on the server's local storage. The server delivers the file segment by segment. The file 224 the client receives contains the concatenated segments 207, 208, 201, 202, 203, 209, 210, 204, 205, and 206.

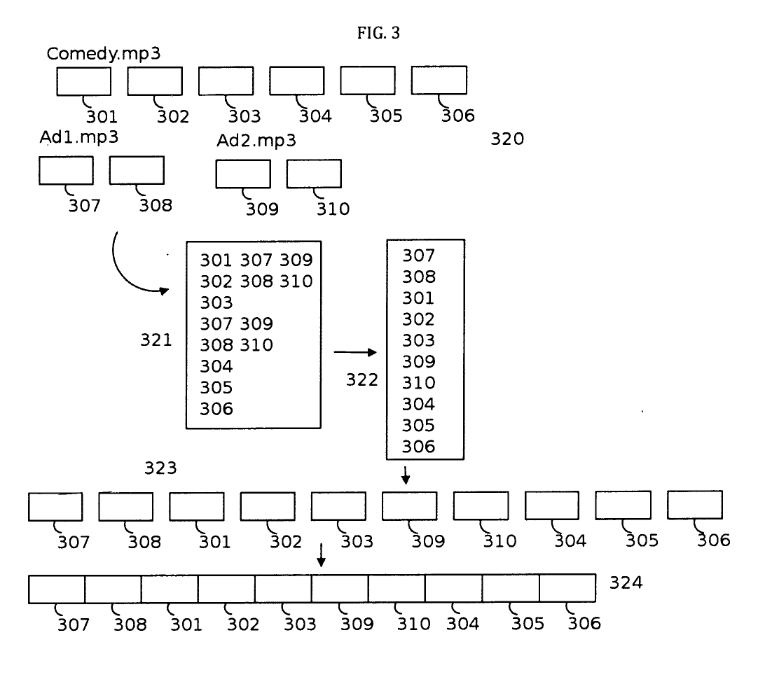

FIG. 3. depicts 320 the original content segments, the candidate segment pointer list 321, the selected segment list 322, the selected segments 323, and the complete file 324, which the client receives. The server receives a client request: GET /comedy.mp3. There are two versions of Comedy.MP3. The versions may have different Segments 301, 302, 303, 304, 305, and 306 contain some number of MP3 frames of data. Segments 301, 302, 303, 304, 305, and 306 correspond to the request URL. The segments were previously generated from splitting the comedy.mp3 file at frame boundaries. The business desires to deliver advertising content to the client along with the comedy audio content. Locations for inserting advertisements are prior to segment 301 and between segment 303 and 304. Segments 307, 308, 309, and 310 contain some number of MP3 frames of data. The segments 307 and 308 were previously generated from splitting the ad1.mp3 and the ad2.mp3 file at frame boundaries. The segments 309 and 310 were previously generated from splitting the ad2.mp3 file at frame boundaries. The original content segments 320 reside on the server's remote or local storage. The candidate segment list 321 is a data structure that lists the candidates that are appropriate based on the request. Business logic is applied to determine which segments are selected. The server determines the best single segment for each position. The segment 307, 309, or 301 may be the first segment of data delivered to the client. The selected segment list 322 is a data structure that lists the selected candidate segments. The selected segment list 322 contains exactly one segment in each position. The selected content segments 323 reside on the server's local storage. The server delivers the file segment by segment. The file 324 the client receives contains the concatenated segments 307, 308, 301, 302, 303, 309, 310, 304, 305, and 306.

In some embodiments, there is a high resolution or higher audio bitrate version of segment one and a low resolution version of each segment.

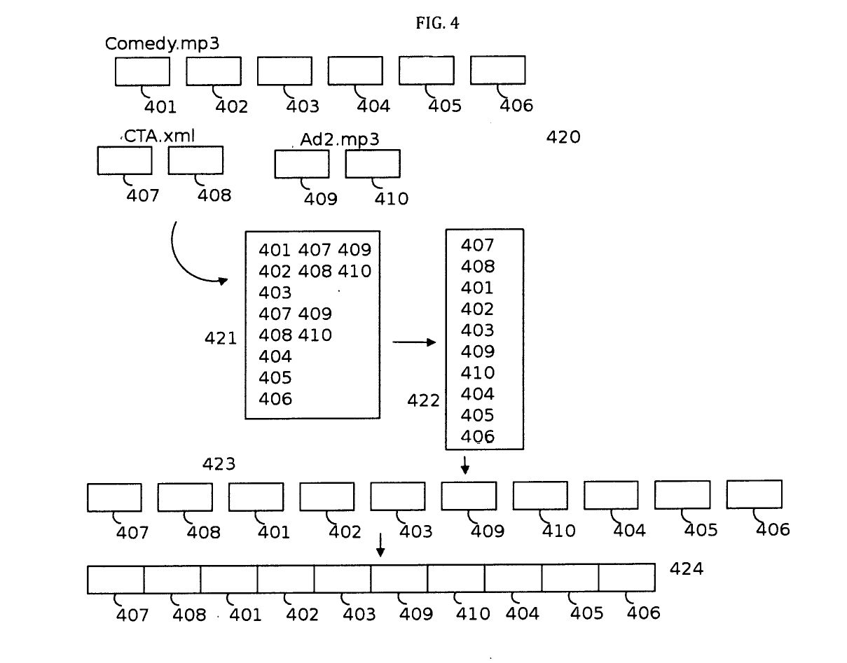

FIG. 4 illustrates some embodiments where the selected segment list may be changed thus changing later segments that are delivered. The server receives a client request: GET /comedy.mp3. Segments 401, 402, 403, 404, 405, and 406 contain some number of MP3 frames of data. Segments 401, 402, 403, 404, 405, and 406 correspond to the request URL. The segments were previously generated from splitting the comedy.mp3 file at frame boundaries. The business desires to deliver advertising content to the client along with the comedy audio content. Locations for inserting advertisements are prior to segment 401 and between segment 403 and 404. Segments 407, 408, 409, and 410 contain some number of MP3 frames of data. The segments 407 and 408 were previously generated from splitting the ad1.mp3 and the ad2.mp3 file at frame boundaries. The segments 409 and 410 were previously generated from splitting the ad2.mp3 file at frame boundaries. The original content segments 420 reside on the server's remote or local storage. The candidate segment list 421 is a data structure that lists the candidates that are appropriate based on the request. Business logic is applied to determine which segments are selected. The server determines the best single segment for each position. The segment 407, 409, or 401 may be the first segment of data delivered to the client. The selected segment list 422 is a data structure that lists the selected candidate segments. The selected segment list 422 contains exactly one segment in each position. The selected segment list may be changed at any point prior to the server's read operation at a particular position. The selected content segments 423 reside on the server's local storage. The server delivers the file segment by segment. The file 424 the client receives contains the concatenated segments 407, 408, 401, 402, 403, 409, 410, 404, 405, and 406.

Switching segments after the first segment has been delivered may be used to deliver a higher or lower quality file to account for changes in client bandwidth. The system determines that client can receive a larger file in the target download time. The client has a fast internet connection, so larger segments can be delivered in an appropriate amount of time. The list of pointers is changed so that later segments are of larger files.

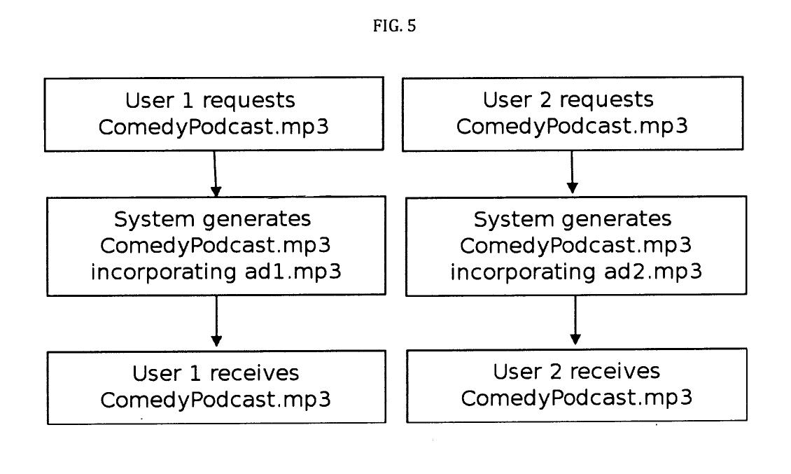

FIG. 5 depicts the production of two different files following the same URL request. In embodiment one, user one receives ad1.mp3 embedded (integrated) in ComedyPodcast.mp3. User two also requests ComedyPodcast.mp3 and receives ad2.mp3 embedded in ComedyPodcast.mp3.

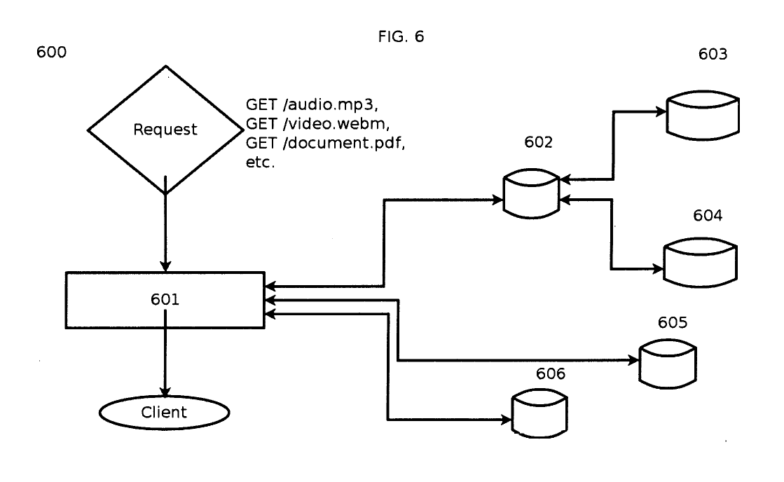

FIG. 6 illustrates system 600 which delivers a generated file, according to some embodiments of the present invention. System 600 includes a business server 601, business API 602, data warehouse 603, database 604, third-party API 605, and storage 606.

Server 601 receives a request from client.

According to some embodiments, business server 601 determines based upon the request, which segments are required to service the request by querying APIs 602 and 605.

Targeting parameters are sent to the business API 602. Targeting parameters that are sent may include whether the user has a content or premium subscription and additional user and client data. The business API 602 returns a list of segment candidates that are appropriate to deliver to the client to the business server 601. The business API 602 queries the data warehouse 603 and database 604 for appropriate segments.

In some embodiments, targeting parameters are sent to third party API 605 to further refine the list of candidate segments. The third party API 605 returns a list of segment candidates that are appropriate to deliver to the client to the business server 601.

Segment data is validated against local and remote storage 606, and segment data is downloaded if it is not available in local storage.

The server computes based on the user data of the user who requested the audio which audio segments could be delivered. A list of pointers is generated that includes the client requested file, as well as any other content that is desired by the business. The system decides to first deliver an advertisement, ad1.mp3. A medium sized version of ad1.mp3 is the file from which segment 1 is taken. The server checks that it has segment1. (Segment1 comes from a content delivery network). The server delivers segment 1. Client receives segment1.

Embodiments of the invention described above are exemplary only. One skilled in the art may recognize various alternative embodiments from those specifically disclosed. Those alternative embodiments are also intended to be within the scope of this disclosure. As such, the invention is limited only by the following claims.

What is claimed:

1. A method for transmitting a content stream through a network to a client comprising the steps of:
receiving a request from the client;
generating a list of candidate segments;
selecting the candidate segments to compose what will be delivered wherein each position is limited to a single candidate segment;
retrieving the plurality of segments selected to be transmitted;
transmitting each selected segment to the client.

2. The method of claim 1, wherein the request from a client is for a file associated with a format.

3. The method of claim 2, wherein the file is selected from a group consisting of an audio file, a multimedia file, and a podcast file.

4. The method of claim 4, wherein the file contains advertising.

5. A system for providing a content stream through a network to a client, comprising:
content storage, an application programming interface, and a server, wherein server is configured to: receive a request from the client for a particular file; generate a list of candidate segments; select the candidate segments to compose what will be delivered wherein each position is limited to a single candidate segment; retrieve the plurality of segments selected to be transmitted; transmit each selected segment to the client.

6. The system of claim 5, wherein the request from a client is for a file associated with a format.

7. The system of claim 6, wherein the file is selected from a group consisting of an audio file, a multimedia file, and a podcast file.

8. The system of claim 7, wherein the file contains advertising.

9. A non-transitory computer readable medium storing a program causing a computer to execute a process, the process comprising:
receiving a request from the client;
generating a list of candidate segments;
selecting the candidate segments to compose what will be delivered wherein each position is limited to a single candidate segment;
retrieving the plurality of segments selected to be transmitted;
transmitting each selected segment to the client.

10. The non-transitory computer readable medium according to claim 9, wherein the file is selected from a group consisting of an audio file, a multimedia file, a podcast file, an advertisement file, and an interactive file.
